(19) United States
(12) Patent Application Publication
(10) Pub. No.: US 2021/0262208 A1
(43) Pub. Date: Aug. 26, 2021

(54) Multiple Head Shower Assembly

(71) Applicant: Junior Garcia, Carmichael, CA (US)

(72) Inventor: Junior Garcia, Carmichael, CA (US)

(21) Appl. No.: 16/802,182

(22) Filed: Feb. 26, 2020

(51) Int. Cl. E03C 1/04; B05B 1/18; B05B 15/658; E03C 1/02

(52) U.S. Cl. CPC E03C 1/0408; E03C 1/025; B05B 15/658; B05B 1/18

(57) ABSTRACT

A multiple head shower assembly includes a rod that has a first end and a second end. The rod is elongated between the first end and the second end to be extended across a shower fixture and the rod is hollow. A bumper is coupled to the first end of the rod to abut a respective wall of the shower fixture. A plunger is movably coupled to the second end of the rod. The plunger is biased into an extended position to compress against a respective wall of the shower. An input hose is fluidly attachable to the rod to transfer fluid into the rod. The fluid source may be an existing shower head in the shower and the fluid may be water. A pair of shower heads is each fluidly attachable to the rod to spray the fluid onto two people for showering.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shower devices and more particularly pertains to a new shower device for facilitating a pair of people to bathe in one shower without sharing a shower head.

### (2) Description of Related Art Including Information Disclosed Under 37 CFR 1.97 and 1.98

The prior art relates to shower devices. The prior art discloses a multiple head shower rod that is integrated into a pre-existing water supply pipe. The prior art discloses a variety of multiple head shower rods that have a fluid supply hose that can be fluidly coupled to an existing shower head in a shower. The prior art also discloses a multiple head shower rod and a divider for dividing a shower into a pair of showers. In no instance does the prior art disclose a multiple head shower rod that includes a shut off valve for blocking fluid flow to one of the shower heads.

### BRIEF SUMMARY OF THE INVENTION

An embodiment of the disclosure meets the needs presented above by generally comprising a rod that has a first end and a second end. The rod is elongated between the first end and the second end to be extended across a shower fixture and the rod is hollow. A bumper is coupled to the first end of the rod to abut a respective wall of the shower fixture. A plunger is movably coupled to the second end of the rod. The plunger is biased into an extended position to compress against a respective wall of the shower. An input hose is fluidly attachable to the rod to transfer fluid into the rod. The fluid source may be an existing shower head in the shower and the fluid may be water. A pair of shower heads is each fluidly attachable to the rod to spray the fluid onto two people for showering.

A shut off valve is coupled to the rod such that the shut off valve is in fluid communication with the interior of the rod. The shut off valve is positioned between the first output and the second output on the rod. The shut off valve is positionable in a closed condition to restrict the fluid from flowing to the second output. Conversely, the shut off valve is positionable in an open condition to facilitate the fluid to flow to the second output. The shut off valve includes a knob that is rotatably positioned on the rod to be manipulated by a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a multiple head shower assembly according to an embodiment of the disclosure.

FIG. 2 is a right side view of an embodiment of the disclosure.

FIG. 3 is a bottom view of an embodiment of the disclosure.

FIG. 4 is a right side in-use view of an embodiment of the disclosure.

FIG. 5 is a detailed view of the portion identified in FIG. 2.

### DETAILED DESCRIPTION OF THE INVENTION

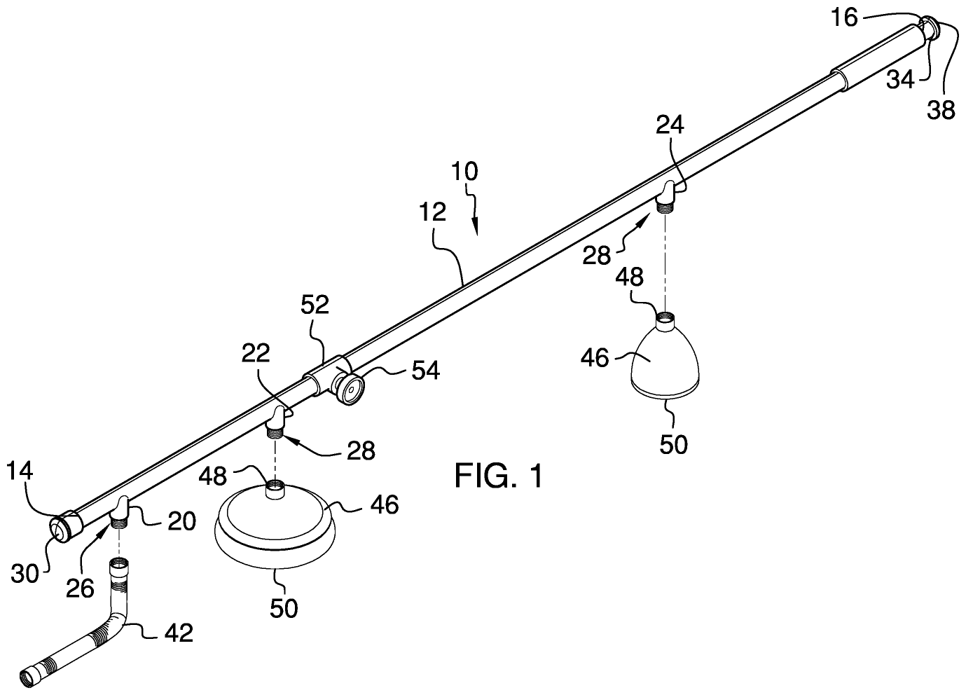

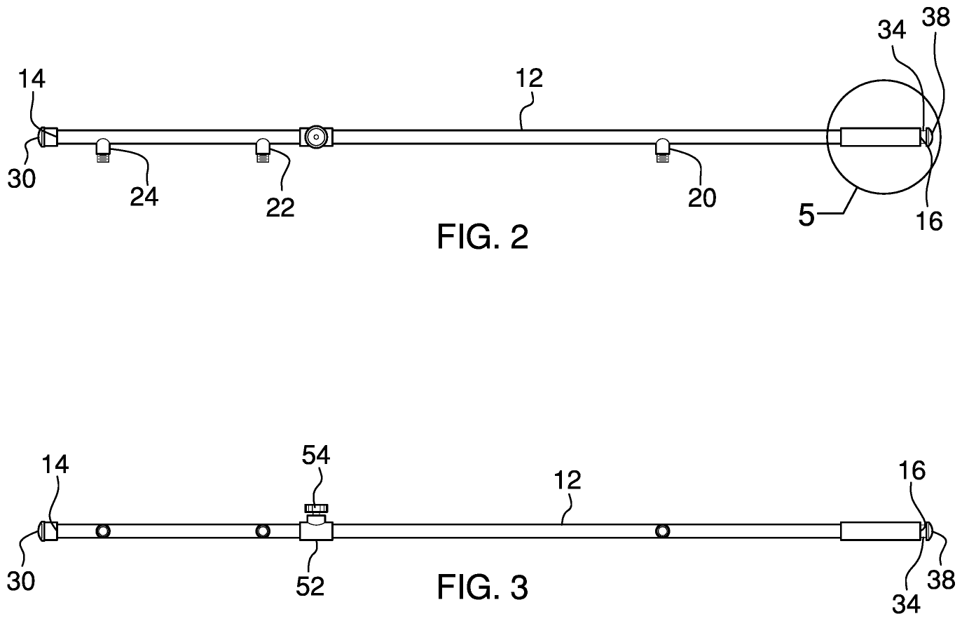

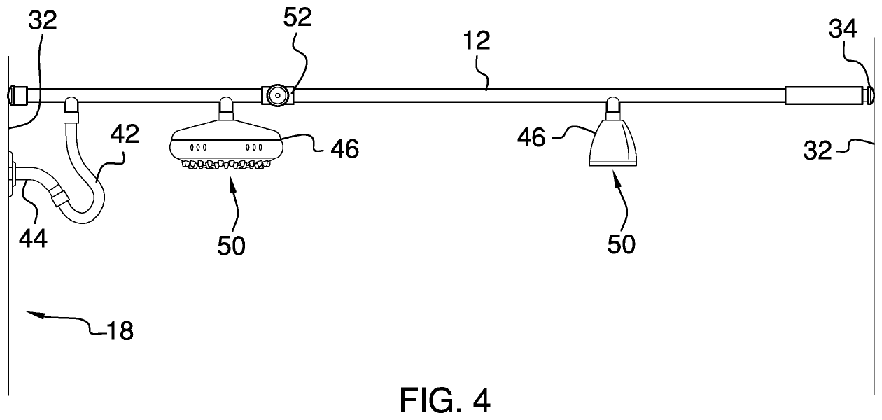

With reference now to the drawings, and in particular to FIGS. 1 through 5 thereof, a new shower device embodying the principles and concepts of an embodiment of the disclosure and generally designated by the reference numeral 10 will be described.

As best illustrated in FIGS. 1 through 5, the multiple head shower assembly 10 generally comprises a rod 12 that has a first end 14 and a second end 16. The rod 12 is sufficiently elongated between the first end 14 and the second end 16 to be extended across a shower fixture 18. The rod 12 is hollow and the rod 12 has an input 20 that is in fluid communication with an interior of the rod 12. Additionally, the rod 12 has a first output 22 and a second output 24 that is each in fluid communication with the interior of the rod 12. The input 20 includes a threaded coupling 26 and each of the first output 22 and the second output 24 includes a threaded coupling 28.

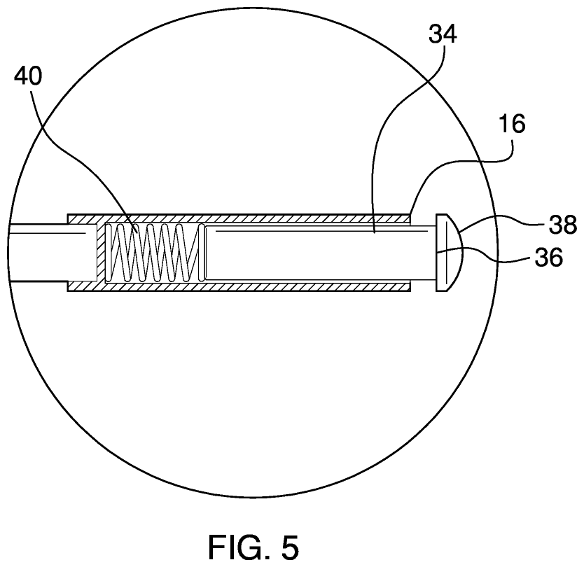

A bumper 30 is coupled to the first end 14 of the rod 12 to abut a respective wall 32 of the shower fixture 18. The bumper 30 is comprised of a resiliently compressible material to frictionally engage the respective wall 32. A plunger 34 is movably coupled to the second end 16 of the rod 12 and the plunger 34 is biased into an extended position to compress against a respective wall 32 of the shower. The plunger 34 is slidably positioned in the second end 16 of the rod 12 and the plunger 34 has a distal end 36 with respect to the second end 16. As is most clearly shown in FIG. 5, a closure 37 is positioned within the rod 12 and is positioned adjacent to the second end 16. In this way the closure 37 inhibits fluid from exiting the second end 16 of the rod 12.

A bumper 38 is coupled to the distal end 36 of the plunger 34 to abut the respective wall 32. The bumper 38 on the plunger 34 is comprised of a resiliently compressible material to frictionally engage the respective wall 32. A biasing member 40 is positioned within the rod 12 and the biasing member 40 engages the plunger 34 for biasing the distal end 36 of the plunger 34 outwardly from the second end 16 of the rod 12.

An input hose 42 is fluidly attachable to the input 20 and the input hose 42 is fluidly attachable to a fluid source 44 to transfer fluid into the rod 12. The fluid source 44 may comprise an existing shower head in the shower and the fluid may be water. A pair of shower heads 46 is provided and each of the shower heads 46 has an inlet 48 and an outlet 50. The inlet 48 of each of the shower heads 46 threadably engages a respective one of the first output 22 or the second output 24 on the rod 12. In this way each of the shower heads 46 receives the fluid from the fluid hose thereby facilitating a pair of users to simultaneously bathe in the shower fixture 18.

A shut off valve 52 is coupled to the rod 12 such that the shut off valve 52 is in fluid communication with the interior of the rod 12. The shut off valve 52 is positioned between the first output 22 and the second output 24 on the rod 12. The shut off valve 52 is positionable in a closed condition to restrict the fluid from flowing to the second output 24. Conversely, the shut off valve 52 is positionable in an open condition to facilitate the fluid to flow to the second output 24. The shut off valve 52 includes a knob 54 that is rotatably positioned on the rod 12 to manipulate the shut off valve 52 between the open condition and the closed condition.

In use, the rod 12 is positioned at a selected location in the shower having the rod 12 being horizontally oriented and extending between the wall 32s of the shower fixture 18. The plunger 34 compresses against the respective wall 32 to retain the rod 12 in position. The input hose 42 is fluidly coupled to the water source and each of the shower heads 46 is fluidly coupled to the respective first output 22 and second output 24. Thus, two people can bathe at the same time in the shower without having to share a shower head.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multiple head shower assembly for being removably positioned within a shower without requiring wall plumbing, said assembly comprising:
a rod having a first end and a second end, said rod being elongated between said first end and said second end wherein said rod is configured to be extended across a shower fixture, said rod being hollow;
a bumper being coupled to said first end of said rod wherein said bumper is configured to abut a respective wall of the shower fixture, said bumper being comprised of a resiliently compressible material wherein said bumper is configured to frictionally engage the respective wall;
a plunger being movably coupled to said second end of said rod, said plunger being biased into an extended position wherein said plunger is configured to compress against a respective wall of the shower;
an input hose being fluidly attachable to said rod, said input hose being fluidly attachable to a fluid source wherein said input hose is configured to transfer fluid into said rod;
a pair of shower heads, each of said shower heads being fluidly attachable to said rod wherein each of said shower heads is configured to spray the fluid onto two people for showering;
a shut off valve being coupled to said rod such that said shut off valve is in fluid communication with said interior of said rod, said shut off valve being positioned between said first output and said second output on said rod, said shut off valve being positionable in a closed condition wherein said shut off valve is configured to restrict the fluid from flowing to said second output, said shut off valve being positionable in an open condition wherein said shut off valve is configured to facilitate the fluid to flow to said second output, said shut off valve including a knob being rotatably positioned on said rod wherein said knob is configured to be manipulated by a user.

2. The assembly according to claim 1, wherein said rod has an input being in fluid communication with an interior of said rod, said rod having a first output and a second output each being in fluid communication with said interior of said rod, said input including a threaded coupling, each of said first output and said second output including a threaded coupling.

3. The assembly according to claim 2, wherein said plunger is slidably positioned in said second end of said rod, said plunger having a distal end with respect to said second end.

4. The assembly according to claim 1, further comprising a bumper being coupled to a distal end of said plunger wherein said bumper on said plunger is configured to abut the respective wall, said bumper on said plunger being comprised of a resiliently compressible material wherein said bumper on said plunger is configured to frictionally engage the respective wall.

5. The assembly according to claim 3, further comprising a biasing member being positioned within said rod, said biasing member engaging said plunger for biasing said distal end of said plunger outwardly from said second end of said rod.

6. The assembly according to claim 2, wherein each of said shower heads has an inlet and an outlet, said inlet of each of said shower heads threadably engaging a respective one of said first output or said second output on said rod wherein each of said shower heads is configured to receive the fluid from said fluid hose thereby facilitating a pair of users to simultaneously bathe in the shower fixture.
A multiple head shower assembly for being removably positioned within a shower without requiring wall plumbing, said assembly comprising:
a rod having a first end and a second end, said rod being elongated between said first end and said second end wherein said rod is configured to be extend across a shower fixture, said rod being hollow, said rod having an input being in fluid communication with an interior of said rod, said rod having a first output and a second output each being in fluid communication with said interior of said rod, said input including a threaded coupling, said first output and said second output including a threaded coupling;
a bumper being coupled to said first end of said rod wherein said bumper is configured to abut a respective wall of the shower fixture, said bumper being comprised of a resiliently compressible material wherein said bumper is configured to frictionally engage the respective wall;
a plunger being movably coupled to said second end of said rod, said plunger being biased into an extended position wherein said plunger is configured to compress against a respective wall of the shower, said plunger being slidably positioned in said second end of said rod, said plunger having a distal end with respect to said second end;
a bumper being coupled to said distal end of said plunger wherein said bumper on said plunger is configured to abut the respective wall, said bumper on said plunger being comprised of a resiliently compressible material wherein said bumper on said plunger is configured to frictionally engage the respective wall;
a biasing member being positioned within said rod, said biasing member engaging said plunger for biasing said distal end of said plunger outwardly from said second end of said rod;
an input hose being fluidly attachable to said input, said input hose being fluidly attachable to a fluid source wherein said input hose is configured to transfer fluid into said rod;
a pair of shower heads, each of said shower heads having an inlet and an outlet, said inlet of each of said shower heads threadably engaging a respective one of said first outputs or said second output on said rod wherein each of said shower heads is configured to receive the fluid from said fluid hose thereby facilitating a pair of users to simultaneously bathe in the shower fixture; and
a shut off valve being coupled to said rod such that said shut off valve is in fluid communication with said interior of said rod, said shut off valve being positioned between said first output and said second output on said rod, said shut off valve being positionable in a closed condition wherein said shut off valve is configured to restrict the fluid from flowing to said second output, said shut off valve being positionable in an open condition wherein said shut off valve is configured to facilitate the fluid to flow to said second output, said shut off valve including a knob being rotatably positioned on said rod wherein said knob is configured to be manipulated by a user.
